(19) United States
(12) Patent Application Publication
(10) Pub. No.: US 2026/0044785 A1
(43) Pub. Date: Feb. 12, 2026

(54) SYSTEM AND METHOD FOR GENERATING A CROSS-DOMAIN MULTILINGUAL MODEL

(71) Applicant: Walmart Apollo, LLC, Bentonville, AR (US)

(72) Inventors: Saurabh Kumar, Aurangabad (IN); Sourav Bansal, Gurgaon (IN); Neeraj Agrawal, Shangaj (IN); Priyanka Bhatt, Faridabad (IN); Sudipta Modak, Marathahalli (IN); Awanish Kumar Singh, Dibrugarh (IN)

(21) Appl. No.: 18/795,564

(22) Filed: Aug. 6, 2024

(51) Int. Cl. G06N 20/20

(52) U.S. Cl. CPC G06N 20/20

(57) ABSTRACT

System and methods for generating a cross-domain multilingual model are disclosed. In some embodiments, a disclosed method includes: storing, in a database, a plurality of first utterances associated with a first language, training a first model using the plurality of first utterances, the first model being associated with the first language, generating, using the first model, a plurality of first representations associated with the plurality of first utterances, training a second model, using the plurality of first representations, the second model being associated with a plurality of second languages, receiving, using the second model, a second utterance in the second language, and generating, using the second model, a response in one or more languages of the plurality of second languages.

### TECHNICAL FIELD

This application relates generally to generating a cross-domain model and, more particularly, to systems and methods for generating a cross-domain multilingual model.

### BACKGROUND

Customer services and communication is an important aspect of e-commerce. Many retailers utilize automation/chat bots to communicate with customers to quickly and efficiently address issues that arise. These chat bots are based off of models and their performance is based on the availability of sufficient domain-specific data. For example, most chat bots are able to provide helpful responses in English, but are unable to parse, understand, or provide responses in other languages.

Traditional models used to train chat bots require building large datasets per domain for training in multiple languages. This requires significant time and resources for building each dataset.

### SUMMARY

The embodiments described herein are directed to systems and methods for generating a cross-domain multilingual model.

In various embodiments, a system including a database storing a plurality of first utterances, the plurality of first utterances being associated with a first language and a computing device comprising at least one processor in communication with the database. The computing device being configured to train a first model using the plurality of first utterances, the first model being associated with the first language, generate, using the first model, a plurality of first representations associated with the plurality of first utterances, train a second model, using the plurality of first representations, the second model being associated with a plurality of second languages, receive, using the second model, a second utterance in the second language, and generate, using the second model, a response in one or more languages of the plurality of second languages.

In some embodiments, the computing device is further configured to generate, using the first model, a plurality of first embeddings associated with the first utterance, generate, using the second model, a plurality of second embeddings associated with the second utterances, and compare the plurality of first embeddings to the plurality of second embeddings to generate a loss comparison. The computing device is further configured to refine the second model based on the loss comparison.

In some embodiments, the first language and the plurality of second languages are different. The plurality of second languages may include the first language.

In some embodiments, the computing device is further configured to generate, using the second model, a plurality of second representations based a plurality of second utterances, and map the plurality of second representations to the plurality of first representations.

In some embodiments, the first model is associated with a single language and the second model is associated with a plurality of languages.

In some embodiments, the first model is trained using an isotropic regularizer.

In some embodiments, the computing device is further configured to generate, using the first model, a plurality of first embeddings associated with the first language, generate, using the second model, a plurality of second embeddings associated with the first language and a plurality of third embeddings associated with the second language, compare the plurality of first embeddings to the plurality of second embeddings to generate a first loss comparison, compare the plurality of first embeddings to the plurality of third embeddings to generate a second loss comparison, generate a distillation loss based on aggregating the first loss comparison and the second loss comparison, and refine the second model based on the distillation loss.

In some embodiments, the computing device is further configured to parse the first utterance and the second utterance to extract text data associated with the first utterance and the second utterance.

In various embodiments, a computer-implemented method is disclosed. The computer-implemented method includes: storing, in a database, a plurality of first utterances associated with a first language, training a first model using the plurality of first utterances, the first model being associated with the first language, generating, using the first model, a plurality of first representations associated with the plurality of first utterances, training a second model, using the plurality of first representations, the second model being associated with a plurality of second languages, receiving, using the second model, a second utterance in the second language, generating, using the second model, a response in one or more languages of the plurality of second languages.

In some embodiments, the first language and the plurality of second languages are different. The plurality of second languages may include the first language.

In some embodiments, the method further includes generating, using the second model, a plurality of second representations based a plurality of second utterances, and mapping the plurality of second representations to the plurality of first representations.

In some embodiments, the first model is associated with a single language and the second model is associated with a plurality of languages.

In some embodiments, the first model is trained using an isotropic regularizer.

In some embodiments, the method further includes generating, using the first model, a plurality of first embeddings associated with the first utterance, generating, using the second model, a plurality of second embeddings associated with the second utterances, and comparing the plurality of first embeddings to the plurality of second embeddings to generate a loss comparison. The method may include refining the second model based on the loss comparison.

In some embodiments, the method further includes generating, using the first model, a plurality of first embeddings associated with the first language, generating, using the second model, a plurality of second embeddings associated with the first language and a plurality of third embeddings associated with the second language, comparing the plurality of first embeddings to the plurality of second embeddings to generate a first loss comparison, comparing the plurality of first embeddings to the plurality of third embeddings to generate a second loss comparison, generating a distillation loss based on aggregating the first loss comparison and the second loss comparison, and refining the second model based on the distillation loss.

In various embodiments, a non-transitory computer readable medium having instructions stored thereon is disclosed. The instructions, when executed by at least one processor, cause at least one device to perform operations including: storing, in a database, a plurality of first utterances associated with a first language, training a first model using the plurality of first utterances, the first model being associated with the first language, generating, using the first model, a plurality of first representations associated with the plurality of first utterances, training a second model, using the plurality of first representations, the second model being associated with a plurality of second languages, receiving, using the second model, a second utterance in the second language, generating, using the second model, a response in one or more languages of the plurality of second languages.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for generating a cross-domain multilingual model, in accordance with some embodiments of the present teaching.

FIG. 2 is a block diagram of multilingual model generator, in accordance with some embodiments of the present teaching.

FIG. 3 is a flow diagram of a system for generating a cross-domain multilingual model, in accordance with some embodiments of the present teaching.

FIG. 4 is a flow diagram of an exemplary model for generating a cross-domain multilingual model, in accordance with some embodiments of the present teaching.

FIG. 5 is an exemplary system architecture for the multilingual model generator of FIG. 2, in accordance with some embodiments of the present teaching.

FIG. 6 is an illustration of utilizing an isotropic regularizer for generating a cross-domain multilingual model, in accordance with some embodiments of the present teaching.

FIG. 7 is an exemplary system architecture for the multilingual model generator of FIG. 2, in accordance with some embodiments of the present teaching.

FIG. 8 is a flow diagram of an exemplary model for generating a cross-domain multilingual model using the multilingual model generator of FIG. 2, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for generating a cross-domain multilingual model. In some embodiments, cross-domain refers to different languages, geography, or channels of communication. In some embodiments, the systems and methods utilize models (e.g., machine learning models) to generate a multilingual model. For example, the systems and method provided herein may be configured to build a dataset for training a multilingual model.

In some embodiments, the system and methods for generating a cross-domain multilingual model utilizes tenant agnostic features that optimize the model loading process. By capturing model source parameters and generating a relative score for optimization, the system and methods disclosed herein can perform distributed loading of model data. This optimization improves the efficiency and frequency of model loading, reducing the time required from weeks to days or even hours and the introduction of a priority-driven schedule pool allows for intelligent execution of model loading based on business criticality. This ensures that high priority applications are given precedence, minimizing latency in the inference layers and improving overall system performance.

In some embodiments, the system and methods provided herein are directed to building a generalized few-shot cross-domain classifier that leverages information across multiple domains. For example, the systems and methods provided herein may provide alignment of vectors paces across multiple domains to enable one or more models to produce language agnostic sentence representations which can capture rich semantic information for downstream classification tasks.

In some embodiments, the system and methods provided herein are directed to training a generalized sentence embedding model useful for cross-domain classification tasks. The model may be configured to be used in multiple domains without requiring a significantly large dataset and/or with a minimal amount of labelled utterances.

The proposed invention aims to solve the problem of creating multilingual models. Conventionally, large datasets are needed for training multilingual models. Further, conventional models utilize fine-tined pre-trained language models that require large datasets in multiple languages to create a multilingual model. The systems and methods provided herein are directed to a creating a cross-domain multilingual model. In some embodiments, the multilingual model is used to provide responses in an e-commerce or retail platform. For example, an e-commerce platform may utilize a multilingual model to converse with a customer in a non-English language to provide customer service to the customer.

In some embodiments, the system and methods provided herein are configured to utilize a knowledge distillation strategy to extend the intelligence of the existing domain specific model (e.g., teacher model) to a cross-domain multilingual model (e.g., student model). The teacher model may be a fine-tuned large language model (LLM) configured to generate sentence embeddings of utterances for a source domain. The student model may be trained to mimic or copy the teacher model in a multilingual configuration, such as mapping utterances with similar meaning to other languages that are similar to the original utterance. In some embodiments, the student model is trained to be deployed in multiple domains by training a classifier with a limited number of examples.

In some embodiments, the system and methods provided herein adopt isotropic regularizes for proving sentence representations generated by the models. The system and methods provided herein may utilize a correlation matrix-based regularizer to regularize supervised training of the teacher model to improve embeddings generated by the teacher model resulting in a more accurate student model.

Furthermore, in the following, various embodiments are described with respect to methods and systems for generating a cross-domain multilingual model. In some embodiments, a disclosed method includes: storing, in a database, a plurality of first utterances associated with a first language, training a first model using the plurality of first utterances, the first model being associated with the first language, generating, using the first model, a plurality of first representations associated with the plurality of first utterances, training a second model, using the plurality of first representations, the second model being associated with a plurality of second languages, receiving, using the second model, a second utterance in the second language, and generating, using the second model, a response in one or more languages of the plurality of second languages.

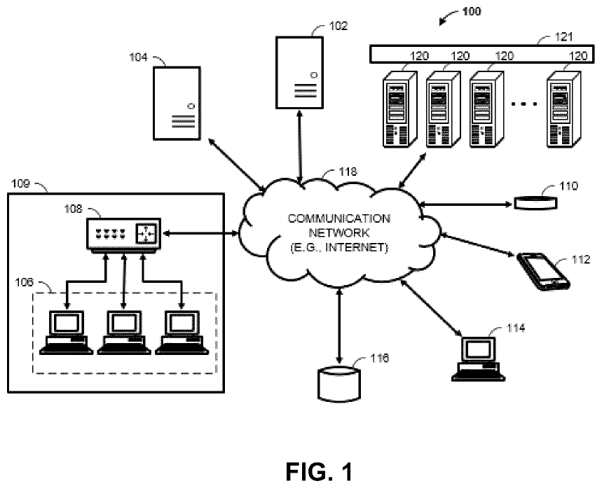

Turning to the drawings, FIG. 1 is a network environment 100 configured to generate a cross-domain multilingual model, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, multilingual model generator (“generator”) 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The generator 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the generator 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the generator 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more applications configured to load models.

The workstation(s) 106 are operably coupled to the communication network 118 via a router (or switch) 108. The workstation(s) 106 and/or the router 108 may be located at a store or corporate headquarters 109 of a retailer, for example. The workstation(s) 106 can communicate with the generator 102 over the communication network 118. The workstation(s) 106 may send data to, and receive data from, the generator 102.

Although FIG. 1 illustrates three user computing devices 110, 112, 114, the network environment 100 can include any number of user computing devices 110, 112, 114. Similarly, the network environment 100 can include any number of the generator 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website or application hosted by the web server 104. The web server 104 may transmit user session data related to a user's activity (e.g., interactions) on the website or application.

In some examples, a user may operate one of the user computing devices 110, 112, 114 to initiate a web browser or application that is directed to a website or application hosted by the web server 104. The user may, via the web browser, view a user interface for viewing and interacting one or more applications. The one or more applications may allow a user to view, interact with, and/or load one or more models. In some embodiments, the applications capture these activities as user session data, and transmit the user session data to the generator 102 over the communication network 118.

The generator 102 is further operable to communicate with the database 116 over the communication network 118. For example, the generator 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the generator 102, in some examples, the database 116 can be a local storage device, such as a hard drive, a non-volatile memory, or a USB stick. The generator 102 may store historical data, business metrics, user data, or data associated prior chat or customer service experiences. Database 116 may be coupled to a computing device. For example, database 116 may be coupled to one or more user computing devices 110, 112, 114 via communication network 118.

In some embodiments, the web server 104 transmits a machine model training request to the generator 102. Upon the machine model training request, the generator 102 may retrieve, e.g. from the database 116, historical data associated with previous loading of models. The generator 102 may train one or more machine models using the historical data. The one or more machine models may be trained to generate outputs for generator 102. The one or more machine models may be trained to generate outputs for generator 102 based on a request from a user. In some embodiments, the one or more machine models are configured to receive feedback from the user to refine or retrain the one or more machine models. For example, a user may transmit a request to generator 102.

In some embodiments, the outputs from the machine model may be used to refine and train the machine model. For example, one or more machine models may be trained using historical data. Generator 102 may receive adjustment or refinement data associated with whether the user made or requested additional adjustments or refinements to the generated outputs. The adjustment data may be inputted into the one or more machine models such that the one or more machine models compares the adjustments to the generated outputs to generate a comparison value. The greater the comparison value the greater the deviation the adjustment is from the generated plan. In other words, the greater the comparison value, the less accurate the one or more machine models are. In some embodiments, the comparison value may be inputted into the one or more machine models to refine the one or more machine models to make the one or more machine models more accurate.

In some examples, the generator 102 assigns the machine models (or parts thereof) for execution to one or more processing devices 120. For example, each machine model may be assigned to a virtual machine hosted by a processing device 120. The virtual machine may cause the machine models or parts thereof to execute on one or more processing units such as GPUs. In some examples, the virtual machines assign each machine model (or part thereof) among a plurality of processing units.

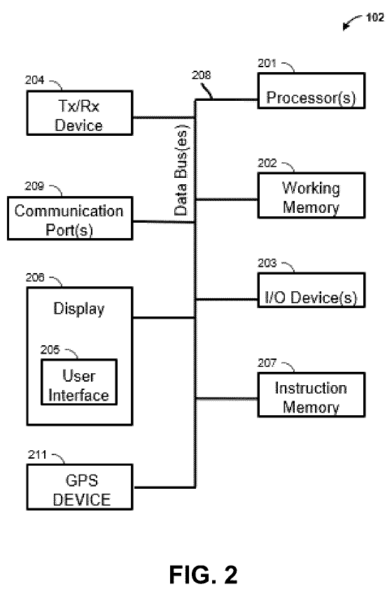

FIG. 2 illustrates a block diagram of generator 102 of FIG. 1, in accordance with some embodiments of the present teaching. In some embodiments, each of the generator 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the generator 102 can be combined, omitted, and/or replicated. In addition, it will be appreciated that additional elements other than those illustrated in FIG. 2 can be added to the generator 102.

As shown in FIG. 2, the generator 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the generator 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the generator 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the generator 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the generator 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the generator 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the generator 102 and/or the web server 104. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the generator 102 may determine a local geographical area (e.g., town, city, state, etc.) of its position.

In some embodiments, the generator 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more machine model training systems that are communicatively coupled with at least one or more machine model database maintaining trained models and one or more training data databases (e.g., database 116) that stores relevant training data to train and/or retrain the one or more machine models used by the generator 102. The machine model training system includes one or more machine model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data associated with previous customer service experiences or interactions. Further, the training data may include historic data, typically for one or more years. Further, the training system is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the machine models to repeatedly provide over time retrained machine models to provide more accurate outputs. This allows the machine models to be refined to provide accurate generated outputs.

The training data databases (e.g., database 116) can be local to the machine model training system, remote and accessible over one or more of the communication networks 118 or a combination of local and distributed. The machine model training system uses the relevant machine learning data to train the machine learning machine models. In some embodiments, one or more training processes are similar to the process performed by one or more machine models after having been trained, but can be trained with multiple sets of training data (e.g., some real and some simulated or synthetic for training). Predictions are compared to actuals to ensure that the set of machine models are operating with a certain threshold confidence. Further, the machine model training system is configured to receive feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more natural language processing (NLP) or natural language understanding (NLU) machine models to process spoken language. In some embodiments, the neural network, machine learning models and/or machine learning algorithms may include, but are not limited to, Large Language models (LLM), Heuristics, Univariate based techniques, Multivariate, control limit, isolation forest and LOF—ensembles, deep learning machine models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such machine models, networks and/or algorithms.

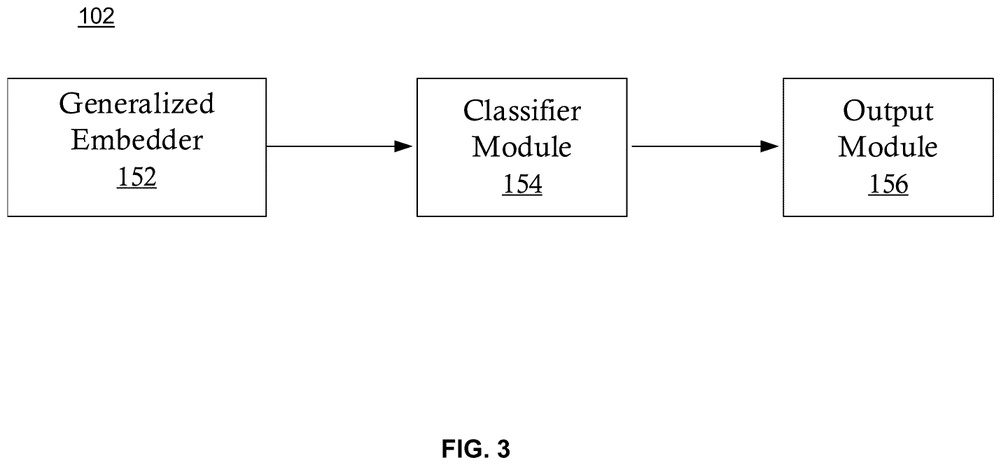

FIG. 3 is a block diagram of generator 102, in accordance with some embodiments of the present teaching. As indicated in FIG. 3, generator 102 may include generalized embedder 152, classifier module 154, and output module 156. Generalized embedder 152 may be trained in a specific language (e.g., English language) and may be configured to generalize output into multiple languages. In some embodiments, generalized embedder 152 is configured to leverage existing label data for utterances (e.g., natural language) for a specific language and produce embedding scores for other languages. In some embodiments, generalized embedder 152 requires only a minimal number of labelled instances.

Classifier module 154 may include one or more models configured to be trained on data generated by generalized embedder 152. For example, generalized embedder 152 may generate a plurality of numerical scores or values. Generalized embedder 152 may be configured to transmit the plurality of numerical scores or values to classifier module 154. Classifier module 154 may train one or more classifier based on the received plurality of numerical scores or values to generate domain-specific labelled utterances. In some embodiments, classifier module 154 utilizes the outputs of generalized embedder 152 to train one or more models for a plurality of domains.

Output module 156 may be configured to utilize the models trained by classifier module 154 to output language (e.g., sentences, responses) in multiple languages. For example, output module 156 may utilize one or more communication modalities (e.g., chat, interactive voice response, e-mail, AI bot, etc.) to provided responses in different languages based on the input (e.g., prompt or query).

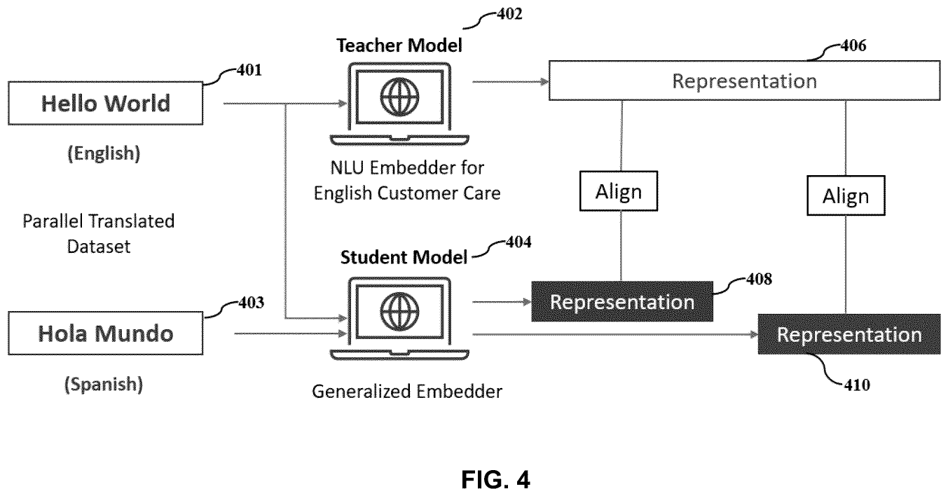

FIG. 4 is an illustration of a first model 402 (e.g., teacher model) and a second model 404 (e.g, student model). In some embodiments, first model 402 is configured to receive a first utterance 401 in a first language (e.g., English). First model 402 may generate a representation 406 of the first utterance 401 and place the representation 406 within a dataset. Second model 404 may include generalized embedder 152 and may be configured to receive a second utterance 403 in a second language (e.g., Spanish). Second model 404 may generate one or more representations 408 of the second utterance 403. Generator 102 may be configured to parse first utterance 401 and second utterance 403 to extract text data associated with each of first utterance 401 and second utterance 403. In some embodiments, first utterance 401 and second utterance 403 are received by generator as voice data and/or text data. In some embodiments, first utterance 401 and second utterance 403 are received via a chat bot, a voice call, an e-mail, or any other form of communication.

In some embodiments, first utterance 401 and second utterance 403 are the same words in different languages. Second model 404 may be configured to align representations 408 and 410 of second model 404 with representation 406 of first model 402 to create an alignment or mapping. In some embodiments, representation 408 is associated with a different language than representation 410. This allows second model 404 to create a mapping of utterances without having to generate a dataset for each language. By mapping and aligning the utterances between different languages, second model 404 is able to output embeddings based on inputs in different languages.

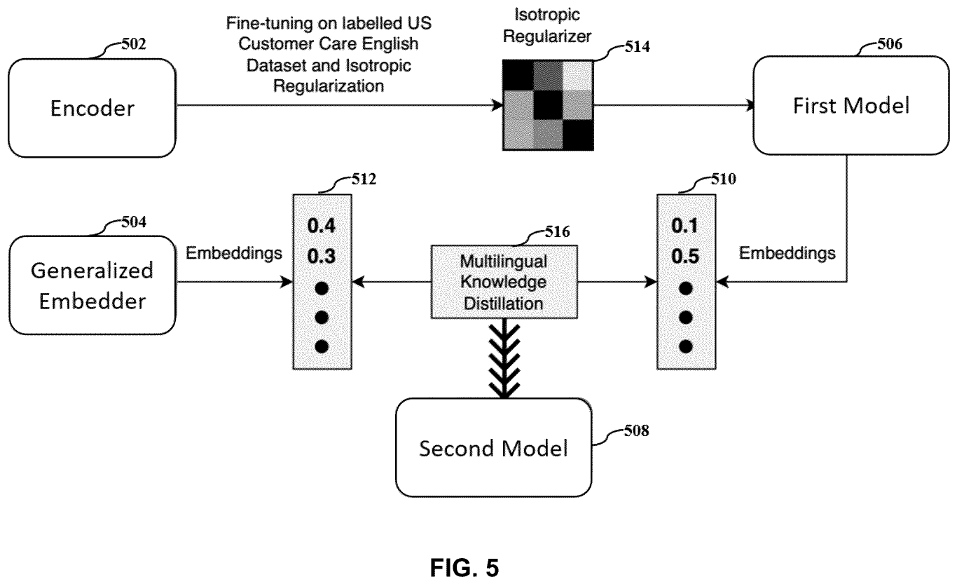

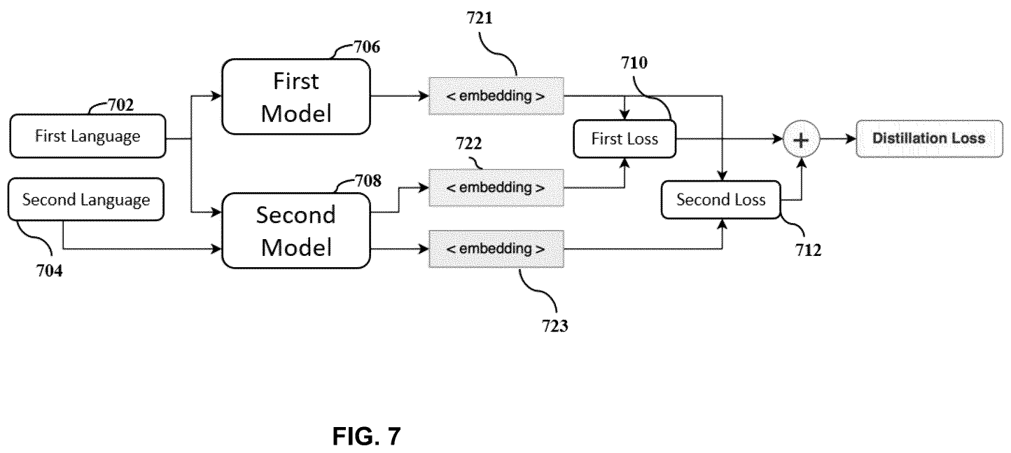

FIG. 5 is an exemplary architecture of generator 102. Encoder 502 may be an encoder for multilingual texts. Encoder 502 may be fine-tuned on labelled first language (e.g., English) dataset and isotropic regularization to generate second model (e.g., teacher model) 506. Generalized embedder 504 may be the same as generalized embedder 152. Generalized embedder 504 may be configured to generate a numerical score or value (e.g., embeddings) for received utterances. In some embodiments first model 506 (e.g., teacher model) generates numerical scores or values (e.g., embeddings 510) based on utterances in the first language. Second model 508 (e.g., student model) may be trained based on distillation of embeddings 510 from first model 506 and generalized embedder 504. In some embodiments, generalized embedder 504 generates numerical scores or values (e.g., embeddings 512) based on utterances in the second language. Generator 102 may utilize a distillation process 516 (e.g., the process illustrated in FIG. 7) that receives the embeddings (e.g., embeddings 510 and 512) to create the second model 508.

Encoder 502 may be configured to tokenize input text. Given an input text x, encoder 502 is configured to tokenize the input text into sequence of tokens x1, x2, . . . xn-2. Encoder may add indicators indicating beginning and end of the sequence. For example, encoder 502 may use [CLS] to indicate the beginning of a sequency and [SEP] to indicate the end of a sequence. In some embodiments, the final sequence of tokens of length n is represented as:

$$x = \{ [ CLS ] , {x}_{1} , {x}_{2} , … , {x}_{n - 2} , [ SEP ] \}$$

Encoder 502 may be configured to encode input tokens and outputs encodings corresponding to each token. Encoder 502 may utilize encoding corresponding to [CLS] token as the representation of the sentence fed.

$$h = BERT ( x )$$

Where, h∈Rd, d is size of the sentence embedding generated.

In some embodiments, encoder 502 is predetermined based on an existing labeled dataset:

$${D}_{s o u r c e}^{l a b e l e d} = \{ ( {x}_{i} , {y}_{i} ) \} ,$$

where yᵢ is the label for utterance x₁. In some embodiments, given

$${D}_{s o u r c e}^{l a b e l e d} = \{ ( {x}_{i} , {y}_{i} ) \}$$

for N different classes, encoder 502 may be fine-tuned. In some embodiments, a linear layer is attached to encoder 502 as the classifier: p(y|hᵢ)=softmax (Whᵢ+b)∈R^{N}, where hᵢ∈R^{N} is the feature representation of x₁ given by a token (e.g., [CLS] token). In some embodiments, W∈R^{NXd} and b∈R^{N} are parameters of the linear layer. In some embodiments, model parameters θ={Ø, W, b} with Ø being the parameters of encoder 502 trained on

$${D}_{s o u r c e}^{l a b e l e d}$$

with a cross-entropy loss

$${θ}^{*} = θ arg min {ℒ}_{ce} ( {D}_{s o u r c e}^{l a b e l e d} ; θ ) .$$

In some embodiments, generator 102 is configured to utilize isotropic regularizers (e.g., regularizer 514) due to pre-training of models resulting in anisotropy. In some embodiments, generator 102 is configured to utilize isotropic regularizers for reducing anisotropy caused by supervised pre-training of the model. Anisotropy may result in sub-optimal performance of pre-trained language models.

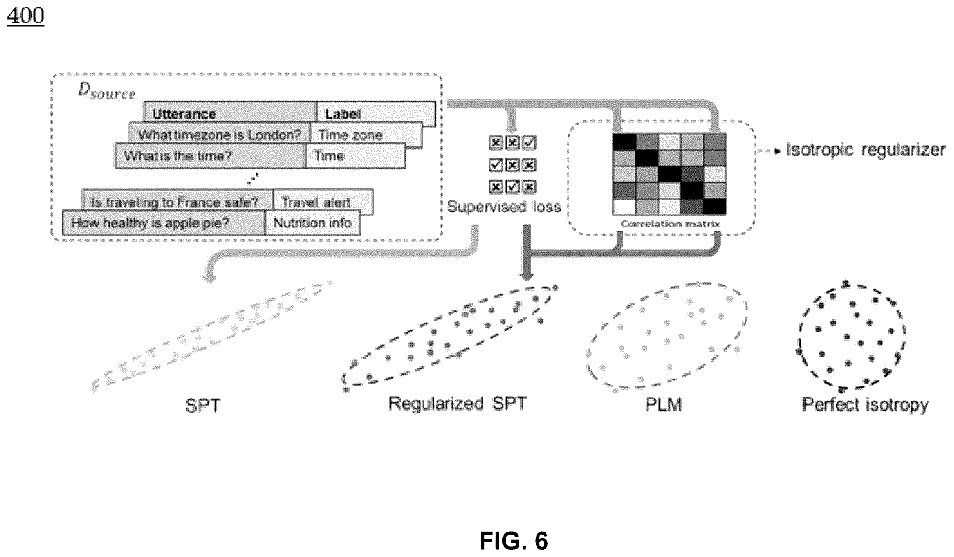

FIG. 6 is an illustration of utilizing an isotropic regularizer on a first model (e.g., teacher model). In some embodiments, isotropization techniques can be applied to adjust the embedding space and yield significant performance improvement in many tasks. As illustrated in FIG. 6, the effect of supervised pre-training and regularized supervised pre-training on isotropy is shown. To mitigate the anisotropy of the pre-trained language model (e.g., the teacher model or first model) fine-tuned by supervised pre-training, a regularization term may be added for isotropization. For example, [symbol] _{reg} may be used for isotropization:

$$ℒ = {ℒ}_{c e} ( {D}_{s o u rce} ; θ ) + {λℒ}_{r e g} ( {D}_{s o u rce} ; θ ) ,$$

where λ is a weight parameter.

In some embodiments, generator 102 utilizes a correlation-matrix based regularizer:

[symbol] _{reg}=∥Σ−1∥, where ∥∥ denotes Frobenius norm, I∈R^{dXd} being the identity matrix and Σ∈R^{dXd} is the correlation matrix with Σᵢⱼ being Pearson correlation coefficient between the iₜₕ dimension and the jₜₕ dimension. In some embodiments, Σ is estimated with utterances in the current batch. In some embodiments, the correlation matrix is pushed towards the identity matrix during training to generate a more isotropic feature space.

FIG. 7 is a flow diagram showing a multilingual knowledge distillation process. In some embodiments, first model 706 (e.g., teacher model) and second model 708 (e.g., student model) may receive a first utterance 702 in a first language (e.g., English). First model 706 may be pre-trained based on the first language and may generate first utterance embeddings associated with the first utterance 702. Second model 708 may receive the first utterance 702 in the first language (e.g., English) and a second utterance 704 in a second language (e.g., Spanish). In some embodiments, the first language is different than the second language. Second Model 708 may generate first utterance embeddings based on the first utterance 702 and second utterance embeddings based on the second utterance 704. Generator 102 may compare the first utterance embeddings generated by the first model 706 and the first utterance embeddings generated by the second model 708 to generate a first loss 710. In some embodiments, generator 102 compares the first utterance embeddings generated by the first model 706 and the second utterance embeddings generated by the second model 708 to generate a second loss 712. The first loss and the second loss may be aggregated into a distillation loss. In some embodiments, the first loss 710 and the second loss 712 are each mean squared error loss. The distillation loss may be used to refine the second model 708.

In some embodiments, first model 706 generates a plurality of first embeddings 721 associated with first language 702. Second model 708 may generate a plurality of second embeddings 722 associated with the first language 702 and may generate a plurality of third embeddings 723 associated with the second language 704. Generator 102 may be configured to compare the plurality of first embeddings 721 with the plurality of second embeddings 722 to generate first loss 710. In some embodiments, generator 102 compares the plurality of third embeddings 723 with the plurality of first embeddings 721 to generate second loss 712. Generator 102 may aggregate and/or compare first loss 710 to second loss 712 to generate distillation loss. In some embodiments, distillation loss is used to refine and/or retrain second model 708.

First model 706 may be trained via regularized supervised pre-training to generate accurate embeddings for a domain (e.g., first utterance 702 in a first language). First model 706 may be used as the teacher model (M) and transfer the intelligence to the second model 708 (e.g., student model) (M). The multilingual knowledge distillation process has been illustrated in FIG. 7. In some embodiments, the first model 706 maps the sentences (e.g., utterance 702) in the source domain (e.g., first language) to a high dimensional vector space (e.g., first utterance embeddings).

For the multilingual distillation process, generator 102 utilizes an unsupervised dataset of parallel translated sentences, denoted as D={((s₁, t₁), . . . , (sₙ, tₙ))}, where s₁ is the sentence (e.g., first utterance) in the source domain language (e.g., first language) and t₁ is the sentence (e.g., second utterance) in the target domain language (e.g., second language). In some embodiments, training of the second model 708 minimizes the mean-squared loss between embeddings generated by the first model 706 and the second model 708. The mean-squared loss is taken between the embeddings of the first model 706 in source language (e.g., first language) and the embeddings of the second model 708 in source language (e.g., first language) as well as the embeddings of the first model 706 in source loss language (e.g., first language) and embeddings of the second model 708 in the target language (e.g., second language). The exact objective for a batch β is mentioned in the equation below:

$$\frac{1}{\vert β \vert} {\sum }_{j ∈ β} [ {( M ( {s}_{j} ) - \hat{M} ( {s}_{j} ) )}^{2} + {( M ( {s}_{j} ) - \hat{M} ( {s}_{j} ) )}^{2}$$

In some embodiments, generator 102 includes a loss function. The loss function may be configured to remove language bias. For example, sentences (e.g., utterances) with similar meanings but in different languages are mapped closer than sentences (e.g., utterances) in the same language with different meanings.

In some embodiments, the second model (e.g., the student model) (M) is generated via the distillation process illustrated in FIG. 7. The second model may be used as a feature extractor for novel few-shot cross-domain multilingual intent classification tasks when used along with a classifier. In some embodiments, the classifier is a parametric one such as a Support Vector Machine (SVM) or a non-parametric one such as nearest neighbor. A parametric classifier may be trained with a few labeled examples provided in a task. In some embodiments, the parametric classifier is configured to generate predictions on unlabeled queries.

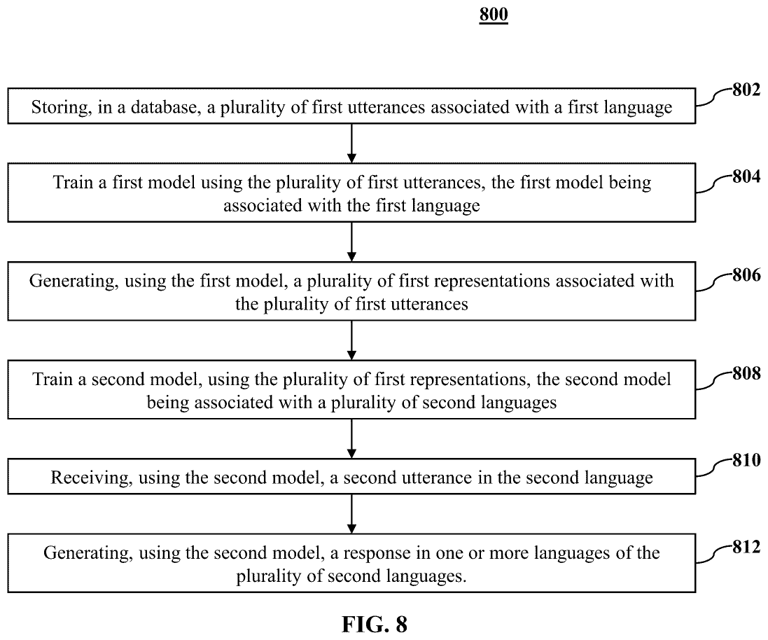

FIG. 8 is a flowchart illustrating an exemplary method for generating a cross-domain multilingual model. At operation 802, generator 102 stores a plurality of first utterances within database 116. Generator 102 may receive the plurality of first utterances from various modalities of communication. The plurality of first utterances may be associated with a first language. At operation 804, generator 102 may train a first model using the plurality of first utterances. In some embodiments, the first model is associated with the first language. The first model may be trained using utterances (e.g., text or sentences) in the first language. In some embodiments, the first model outputs responses in the first language.

At operation 806, generator 102 may generate, using the first model, a plurality of first representations associated with the plurality of first utterances. The plurality of first representation may be output of the first model in response to the first utterances. At operation 808, generator 102 may train a second model using the plurality of first representations. In some embodiments, the second model is associated with a plurality of second languages. The plurality of second languages may be different from the first language. In some embodiments, the plurality of second languages includes the first language. At operation 810, generator 102 may receive, using the second model, a second utterance in the second language. The second utterances may be received from a chat, voice receiver, e-mail, or any other form of communication. At operation 812, generator 102 may generate, using the second model, a response in one or more languages of the plurality of second languages

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing a plurality of first utterances, the plurality of first utterances being associated with a first language;
a computing device comprising at least one processor in communication with the database, the computing device being configured to:
train a first model using the plurality of first utterances, the first model being associated with the first language;
generate, using the first model, a plurality of first representations associated with the plurality of first utterances;
train a second model, using the plurality of first representations, the second model being associated with a plurality of second languages;
receive, using the second model, a second utterance in the second language; and
generate, using the second model, a response in one or more languages of the plurality of second languages.

2. The system of claim 1, wherein the computing device is further configured to:
generate, using the first model, a plurality of first embeddings associated with the first utterance;
generate, using the second model, a plurality of second embeddings associated with the second utterances; and
compare the plurality of first embeddings to the plurality of second embeddings to generate a loss comparison.

3. The system of claim 2, wherein the computing device is further configured to:
refine the second model based on the loss comparison.

4. The system of claim 1, wherein the first language and the plurality of second languages are different.

5. The system of claim 1, wherein the plurality of second languages includes the first language.

6. The system of claim 1, wherein the computing device is further configured to:
generate, using the second model, a plurality of second representations based a plurality of second utterances; and
map the plurality of second representations to the plurality of first representations.

7. The system of claim 1, wherein the first model is associated with a single language and the second model is associated with a plurality of languages.

8. The system of claim 1, wherein the first model is trained using an isotropic regularizer.

9. The system of claim 1, wherein the computing device is further configured to:
generate, using the first model, a plurality of first embeddings associated with the first language;
generate, using the second model, a plurality of second embeddings associated with the first language and a plurality of third embeddings associated with the second language;
compare the plurality of first embeddings to the plurality of second embeddings to generate a first loss comparison;
compare the plurality of first embeddings to the plurality of third embeddings to generate a second loss comparison;
generate a distillation loss based on aggregating the first loss comparison and the second loss comparison; and
refine the second model based on the distillation loss.

10. The system of claim 1, wherein the computing device is further configured to:
parse the first utterance and the second utterance to extract text data associated with the first utterance and the second utterance.

11. A method comprising:
storing, in a database, a plurality of first utterances associated with a first language;
training a first model using the plurality of first utterances, the first model being associated with the first language;
generating, using the first model, a plurality of first representations associated with the plurality of first utterances;
training a second model, using the plurality of first representations, the second model being associated with a plurality of second languages; and
receiving, using the second model, a second utterance in the second language; and
generating, using the second model, a response in one or more languages of the plurality of second languages.

12. The method of claim 11, wherein the first language and the plurality of second languages are different.

13. The method of claim 11, wherein the plurality of second languages includes the first language.

14. The method of claim 11 further comprising:
generating, using the second model, a plurality of second representations based a plurality of second utterances; and
mapping the plurality of second representations to the plurality of first representations.

15. The method of claim 11, wherein the first model is associated with a single language and the second model is associated with a plurality of languages.

16. The method of claim 11, wherein the first model is trained using an isotropic regularizer.

17. The method of claim 11 further comprising:
generating, using the first model, a plurality of first embeddings associated with the first utterance;
generating, using the second model, a plurality of second embeddings associated with the second utterances; and
comparing the plurality of first embeddings to the plurality of second embeddings to generate a loss comparison.

18. The method of claim 17 further comprising:
refine the second model based on the loss comparison.

19. The method of claim 11 further comprising:
generating, using the first model, a plurality of first embeddings associated with the first language;
generating, using the second model, a plurality of second embeddings associated with the first language and a plurality of third embeddings associated with the second language;
comparing the plurality of first embeddings to the plurality of second embeddings to generate a first loss comparison;
comparing the plurality of first embeddings to the plurality of third embeddings to generate a second loss comparison;
generating a distillation loss based on aggregating the first loss comparison and the second loss comparison; and
refining the second model based on the distillation loss.

20. A non-transitory computer readable medium having instructions stored thereon, wherein the instructions, when executed by at least one processor, cause at least one device to perform operations comprising:
storing, in a database, a plurality of first utterances associated with a first language;
training a first model using the plurality of first utterances, the first model being associated with the first language;
generating, using the first model, a plurality of first representations associated with the plurality of first utterances;
training a second model, using the plurality of first representations, the second model being associated with a plurality of second languages;
receiving, using the second model, a second utterance in the second language; and
generating, using the second model, a response in one or more languages of the plurality of second languages.
